(19) United States
(12) Patent Application Publication
(10) Pub. No.: US 2003/0011260 A1
(43) Pub. Date: Jan. 16, 2003

(54) Arrangement of electric machines

(75) Inventor: Jens Hamann, Furth (DE)

Correspondence Address: HENRY M FEIEREISEN, 350 FIFTH AVENUE, SUITE 3220, NEW YORK, NY, 10118, US

(73) Assignee: Siemens Aktiengesellschaft, Muenchen (DE)

(21) Appl. No.: 10/022,478

(22) Filed: Dec. 17, 2001

(30) Foreign Application Priority Data
Jul. 11, 2001 (DE) 101 33 653.5

(51) Int. Cl. H02K 7/20

(52) U.S. Cl. 310/112

(57) ABSTRACT

In an arrangement of a plurality of electric machines, the electric machines are defined by axes in parallel relationship, wherein the electric machines include a common stator which incorporates a plurality of stator portions. The stator portions of the stator cooperate with rotors which are insertable in the stator portions, whereby the number of rotors corresponds to the number of the axes of the electric machines.

### CROSS-REFERENCES TO RELATED APPLICATIONS

This application claims the priority of German Patent Application Serial No. 101,33,653. 5, filed Jul. 11, 2001, the subject matter of which is incorporated herein by reference.

### BACKGROUND OF THE INVENTION

The present invention relates, in general, to an arrangement of electric machines.

Electric machines typically include a stationary stator having slots for receiving windings. A rotor, which represents the moving part of the electric machine, generates the excitation. Stator as well as rotor are arranged point-symmetric with respect to the axis of the electric machine. The shaft of the electric machine extends in alignment with the axis and operates essentially power machines, for example, machine tools, pumps etc.

There are applications that require several electric machines to be disposed in a narrow space such that their axes extend substantially in parallel relationship. This is the case in particular when multiple spindle machines of machine tools are involved. Hereby, the individual spindles are each operated by an electric machine. Each electric machine has its own stack of stator laminations and stack of rotor laminations, which are spatially separated from one another. Assembly of, for example, a multiple spindle machine thus requires sufficient geometric dimensions in order to accommodate the required electric machines while still effecting a sufficient cooling action.

It would therefore be desirable and advantageous to provide an improved arrangement of electric machine, which is so configured as to further reduce the need for space while still improving thermal exploitation of the overall arrangement in comparison to conventional arrangements.

### SUMMARY OF THE INVENTION

According to one aspect of the present invention, in an arrangement of a plurality of electric machines, the electric machines are defined by axes in parallel relationship, wherein the electric machines have a common stator which incorporates a plurality of stator portions that cooperate with rotors insertable in the stator portions, wherein the number of rotors corresponds to the number of the axes of the electric machines.

The present invention resolves prior art problems by providing a common stator for all electric machines, thereby reducing the outer dimensions so that the arrangement can be installed in even tight spaces. A common, single-piece configuration of the stator saves also additional assembly steps for fabricating the arrangement according to the present invention.

The common stator may have a laminated configuration, whereby the stator is formed by stacking single piece metal sheets in axial direction. As an alternative, the common stator may also be made of composite materials or by a combination of laminated parts and composite materials.

The arrangement of such electric machines may have any suitable geometric configuration, e.g. a polygonal shape, a round shape or a linear shape of side-by-side disposition of the electric machines. The arrangement according to the present invention is in particular suitable for multiple spindle machines having six motors disposed in a circle, because such a disposition results in an arrangement of electric machines in which each electric machine occupies a segment of about 60°.

According to another feature of the present invention, the arrangement includes a cooling unit. Examples of such a cooling unit include the provision of an outer cooling jacket and/or a cooling in mid-section of the arrangement. A central cooling is appropriate for circular arrangement of the electric machines in order to further reduce the outer installation dimensions. In the event of a side-by-side disposition of the electric machines in a substantially linear alignment, the cooling unit is suitable placed between two neighboring electric machines. Of course, combinations of cooling systems are also conceivable without departing from the spirit of the present invention. For example, some areas may have an outer cooling jacket as well as an inner cooling jacket. Examples of a coolant medium include air or liquid coolants.

According to another feature of the present invention, each stator portion of the common stator has circumferentially spaced slots, whereby the slots disposed in the area of the overlap zones between immediately neighboring stacks of laminations have a geometry which is so configured as to optimize the magnetic field in the area of immediately neighboring stacks of laminations. Suitably, the width an the depth of these slots are selected to realize an optimal magnetic field.

According to another feature of the present invention, flux barriers may be provided between individual stator portions of immediately neighboring electric lamination stacks. Flux barriers may be implemented through provision of slots in the respective metal sheet or by using non-magnetic materials in these locations.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a sectional illustration of an exemplified multiple spindle machine having incorporated six electric machines in an arrangement according to the present invention;

FIG. 2 is a sectional illustration of a side-by-side arrangement of electric machines in accordance with the present invention; and

FIG. 3 is an enlarged detailed view of an area encircled in FIG. 1 showing the zone between neighboring electric machines in accordance with a modified embodiment of the present invention.

### DETAILED DESCRIPTION OF PREFERRED EMBODIMENTS

Throughout all the Figures, same or corresponding elements are generally indicated by same reference numerals.

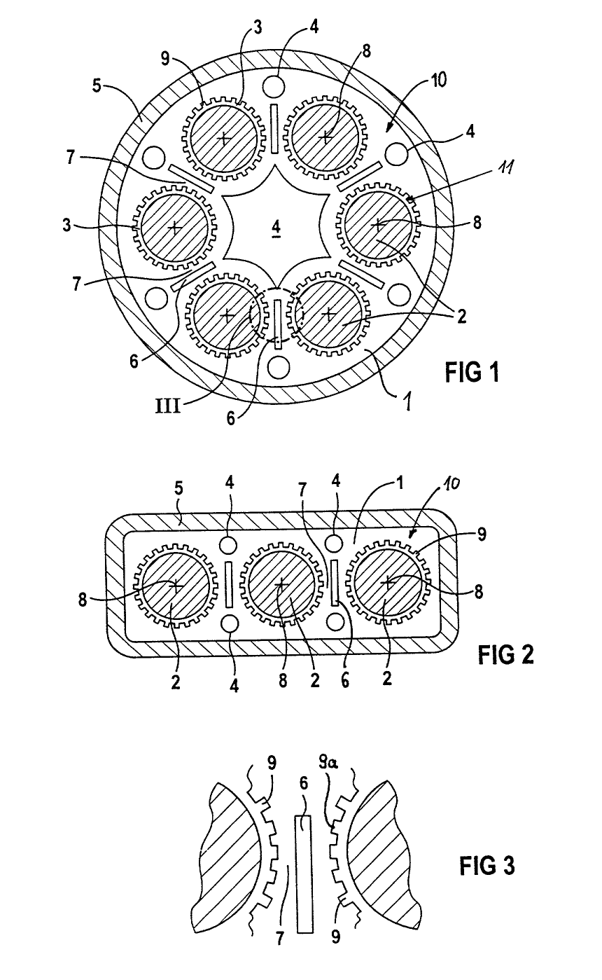

Turning now to the drawing, and in particular to FIG. 1, there is shown a sectional illustration of a machine tool in the form of an exemplified multiple spindle machine having incorporated six electric machines in an arrangement according to the present invention. For the sake of simplicity, the electric machines will be described hereinafter only in connection with those parts that are necessary for the understanding of the present invention. It will be appreciated by persons skilled in the art that the electric machines must contain much mechanical apparatus which does not appear in the foregoing Figures. However, this apparatus, like much other necessary apparatus, is not part of the invention, and has been omitted from the Figures for the sake of simplicity.

The electric machines have a common stator 10 in the form of a stack of single-piece laminations 1. Although not shown in the drawing, the stator 10 may also be made of composite materials or by a combination of laminated parts and composite material. Examples of composite materials include materials based on iron and capable to guide the magnetic field without encountering excessive eddy current losses. Metal powder being useable here include ferrous alloys, copper, nickel etc.

The laminations I are formed with punchings or cutouts, here six and generally designated by reference numeral 11, for defining stator portions and accommodating rotors 2 at formation of respective air gaps between the rotors 2 and the stator lamination stack that includes the stator portions. The electric machines are defined by respective axes 8 which are disposed in parallel relationship. The laminations 1 are further formed with punchings for providing possible cooling channels 4 and slits for providing flux barriers 6. The stator portions of the stator 10 have slots 9 for placement of coils and windings, not shown. An arrangement in this way is optimized as far as space demands are concerned and thus is applicable also in smaller casings for power classes that were previously jot considered. The rotors 2 may suitably be permanently excited rotors.

The flux barriers 6 in overlap zones 7 between immediately neighboring electric machines properly route the magnetic flux between the individual electric machines and are implemented by slits in the laminations 1. Alternatively, instead of slits in the metal sheets, the flux barriers 6 may also be implemented through use of suitable non-magnetic material that is known to a persons skilled in the art. Examples of non-magnetic material include plastics or light metals, e.g. aluminum. The cooling channels 4 may be formed at a peripheral area of the laminations 1 and radially inwards in a mid-section, as shown in the embodiment of FIG. 1, which depicts the electric machines in a circular disposition. The central cooling channel 4 may have a star-shaped configuration, as shown. Of course, other configurations are equally conceivable, e.g., a circular shape. The star-shaped configuration is presently preferred because of the enhanced cooling action at the center-proximal side of the individual electric machines.

The cooling action can be further enhanced in the outer areas that are radially outside of the stator portions of the electric machines by providing a cooling jacket 5 which circumscribes the entire stator 10 of the arrangement, i.e., the stack of laminations 1. The cooling jacket has incorporated therein cooling channels, not shown, which contain a coolant, e.g., air or a suitable liquid. Thus, the cooling channels 4 and the cooling jacket 5 should be configured for circulation of air of liquids to ensure the operational safety of the electric machines. In particular, when a liquid-based cooling action is involved, care should be taken to provide proper sealing measures.

In addition to the flux barriers 6, the magnetic flux in the overlap zones 7 can also be controlled by suitably configuring the width and depth of the slots 9 of the stator portions of the common stator 10 so as to conduct and configure the magnetic field in this overlap zone 7.

Turning now to FIG. 2, there is shown a sectional illustration of a side-by-side arrangement of electric machines in accordance with the present invention. Parts corresponding with those in FIG. 1 are denoted by identical reference numerals and not explained again. In this embodiment, provision is made for a linear disposition of the electric machines, instead of the circular disposition in FIG. 1. The laminations 1 of the stator stack is formed here by way of example with three cutouts 11 for placement of the rotors 2. The axes 8 of the rotors 2 and thus the electric machines are also disposed in parallel relationship. Also in this embodiment, any type of coil or winding can be placed in the slots 9 of the stator portions of the common stator 10. Formed in the overlap zones between neighboring electric machines are the slotted flux barriers 6, and punchings are provided to provide the cooling channels 4. The stator 10 is embraced by a cooling jacket 5.

FIG. 3 shows an enlarged detailed view of an area encircled in FIG. 1, to illustrate a modified embodiment of the electric machines in the overlap zone 7 between neighboring electric machines, involving a variation of the configuration of the slots 9 of the stator 10. In accordance with the present invention, the stator portions of the stator 10 has in the area of the overlap zones 7 slots 9a which have a reduced slot depth and/or slot width compared to the remaining slots 9 so as to optimize the magnetic field in the overlap zones 7.

While the invention has been illustrated and described as embodied in an arrangement of electric machines, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. In an arrangement of a plurality of electric machines, the electric machines are defined by axes in parallel relationship, wherein the electric machines include a common stator which incorporates a plurality of stator portions that cooperate with rotors insertable in the stator portions, wherein the number of rotors corresponds to the number of the axes of the electric machines.

2. The arrangement of claim 1, wherein the stator is made by at least one construction selected from the group consisting of laminated structure and composite material structure.

3. The arrangement of claim 1, and further comprising cooling means for cooling at least parts of the arrangement.

4. The arrangement of claim 3, wherein the cooling means includes a cooling channel disposed centrally in the stator.

5. The arrangement of claim 3, wherein the cooling means includes a cooling jacket at least partially circumscribing the stator.

6. The arrangement of claim 1, and further comprising optimizing means for optimization of a magnetic field at overlap zones of magnetic fields of the arrangement.

7. The arrangement of claim 6, wherein the optimizing means optimize magnetic fields between neighboring electric machines.

8. The arrangement of claim 6, wherein each stator portion of the stator has a circumference and includes slots which are spaced about the circumference and define first slots in the area of the overlap zones and remaining second slots, wherein the first slots have a geometry which differs from a geometry of the second slots.

9. The arrangement of claim 8, wherein the first and second slots have a depth and a width, wherein the depth and the width of the first slots is smaller than the depth and the width of the second slots.

10. The arrangement of claim 6, wherein the optimizing means includes flux barriers.

11. The arrangement of claim 10, wherein the flux barriers are realized by slits.

12. The arrangement of claim 10, wherein the flux barriers are realized by non-magnetic material.

13. The arrangement of claim 1 for use in machine tools.

14. The arrangement of claim 13, wherein the machine tools are multi-spindle machines.

15. A multiple electric machine system, comprising:
a single stator having a plurality of cutouts;
a plurality of rotors, each of the rotors being disposed in a corresponding one of the cutouts, whereby the rotors and the cutouts are placed into one-to-one correspondence, to thereby realize a plurality of electric machines in side-by-side disposition with axes in parallel relationship.

16. The system of claim 15, wherein the cutouts are evenly spaced about a circumference of the stator so that the electric machines are disposed in a circular configuration.

17. The system of claim 15, wherein the cutouts are arranged next to one another in a linear alignment so as to realize a linear disposition of the electric machines.

18. The system of claim 15, wherein each of the cutouts of the stator is so configured as to be bounded about its circumference by spaced-apart slots for placement of windings.

19. The system of claim 15, wherein the stator is composed of a stack of laminations.

20. The system of claim 15, and further comprising cooling means formed in the stator.

21. The system of claim 20, wherein the cooling means includes at least one of a cooling arrangement selected from the group consisting of a first cooling channel disposed centrally in the stator for circulation of a coolant, second cooling channels formed about a periphery of the stator for circulation of a coolant, and a cooling jacket at least partially circumscribing the stator.

22. The system of claim 18, wherein the circumferential slots define first slots in an area between neighboring electric machines and remaining second slots, wherein the first slots have a geometry which differs from a geometry of the second slots, to thereby optimize a magnetic field in the area between neighboring electric machines.

23. The system of claim 22, wherein the first and second slots have a depth and a width, wherein the depth and the width of the first slots is smaller than the depth and the width of the second slots.

24. The system of claim 15, and further comprising flux barriers realized by slits in the stator for routing the magnetic flux in an area between neighboring electric machines.
